(19) United States
(12) Patent Application Publication
(10) Pub. No.: US 2010/0245419 A1
(43) Pub. Date: Sep. 30, 2010

(54) INKJET CARTRIDGE PEN

(75) Inventors: Nick Grisolia, Lake Geneva, WI (US); Peter Greenley, Lake Geneva, WI (US)

Correspondence Address: ADAM K. SACHAROFF;MUCH SHELIST DENENBERG AMENT & RUBENSTEIN, 191 N. WACKER DRIVE, Suite 1800, CHICAGO, IL, 60606-1615, US

(73) Assignee: G2 INVENTIONS, LLC, Lake Geneva, WI (US)

(21) Appl. No.: 12/731,800

(22) Filed: Mar. 25, 2010

Related U.S. Application Data
(60) Provisional application No. 61/163,709, filed on Mar. 26, 2009.

(51) Int. Cl. B41J 29/38

(52) U.S. Cl. 347/9; 347/109

(57) ABSTRACT

A hand-held ink jet device constructed for use with insertable ink jet print/cartridges to produce ink droplet streams is provided. The device includes a memory capable of storing at least one image pattern. A driver coupled to the inkjet jets and being selectively actuatable for providing ink jetting electrical energy pulses. A selector switch for electively choosing one of the at least one image patterns stored on the memory. In addition, a spray switch is provided for selectively actuating the driver to provide electrical energy pulses to energize the respective jets in order to spray ink from the self-contained ink supply in the shape of the selected image pattern.

### CROSS REFERENCE TO RELATED APPLICATION

The present application claims priority to U.S. Patent 61/163,709 filed Mar. 26, 2009.

### FIELD OF THE INVENTION

The present invention relates generally to a hand held digital airbrush pen having an inkjet print cartridge as the supply of ink.

### BACKGROUND OF THE INVENTION

Airbrushes commonly refer to a hand-held device for spraying liquid with an air stream. These devices find use in various fields such as touch-up painting, drawing shading and other applications where it is useful to apply a liquid spray in a controlled manner. Airbrushes currently in use incorporate many complex and expensive mechanical parts that are typically manufactured from brass or stainless steel. Typical airbrushes have several problems in addition to their expense and complexity. The operator is required to have a source of gas flow, such as a compressor or can of compressed nitrogen, that must be connected to the air brush by an awkward hose that limits the operator's freedom of movement. In addition, airbrushes require the skill of an artist to draw or color. The use of an airbrush by a child or a person with limited artistic skill is not widely done. It would therefore be advantageous to provide an airbrush that could draw shapes or other objects without a highly developed artistic skill, making the airbrush enjoyable for kids and children.

### SUMMARY OF THE INVENTION

One embodiment of the present invention is to provide a hand-held spray device of simple and inexpensive design that provides functional advantages over the aforedescribed airbrush. This one embodiment is achieved by incorporating the use of drop-on-demand ink jet technology in a hand-held spray device. The device would be constructed for use with insertable ink jet print/cartridges to produce ink droplet streams. The device would further include a memory capable of storing at least one image pattern; an ink jet print/cartridge of the type having a self-contained ink supply, a plurality of orifices and a plurality of discrete jets energizable respectively for ejection of ink droplets through such orifices; a plurality of discrete drivers electrically coupled to the plurality of discrete print/cartridge jets, with the drivers being selectively actuatable for providing ink jetting electrical energy pulses; a selector switch for electively choosing one of the at least one image patterns stored on the memory; and a spray switch for selectively actuating the discrete drivers to provide electrical energy pulses to energize their respective jets in order to spray ink from the self-contained ink supply in the shape of the selected image pattern.

In other embodiments the device may include a memory capable of storing at least two image patterns. In addition, one of the selected image patterns could include multiple component images, such that the activation and deactivation of the spray switch is capable of rendering different component images of the selected image pattern. In yet other embodiment, the device may include a visual indicator light positioned on a front surface of the device adjacent or near the plurality of orifices. The visual indicator light would be capable of casting a fixed focal light point on a surface to indicate the area the ink will spray.

And in yet other embodiments, the device may include a pressure sensor positioned on a front surface of the device adjacent or near the plurality of orifices to measure an ink pressure applied to a surface. The pressure sensor would be in communication with a microcontroller to control the width or weight of the ink line in response to the pressure applied to a surface. Alternatively, a pressure sensor can be directly in communication with the spray button, such that the pressure on the spray button will dictate the weight of the line of ink jetting from the orifice. Furthermore, the device may include a motion feedback sensor capable of monitoring the movement of the front surface of the device adjacent or near the plurality of orifices across a surface. The motion feedback sensor would be in communication with a microcontroller to control a timing of the activation of the jets in response to the movement of the device.

The incorporation of drop-on-demand ink jet technology in a hand-held spray device overcomes the aforementioned limitations of the conventional airbrush. The spray device may contain its own power source eliminating the necessity of a hose connection and colors may be changed easily by changing the insertable print/cartridge.

### BRIEF DESCRIPTION OF THE DRAWINGS

A fuller understanding of the foregoing may be had by reference to the accompanying drawings, wherein:

FIG. 1A is a top view of a device made in accordance with the one embodiment of the present invention;

FIG. 1B is a side view of the device made in accordance with the one embodiment of the present invention;

FIG. 1C is a side view of the device illustrating the internal hardware components in accordance with the one embodiment of the present invention;

FIG. 2 is a view of one print/cartridge construction useful in accord with the present invention;

FIG. 3 is a block diagram that may be employed for one embodiment of the present invention;

FIG. 4 is an illustration showing airbrushing pattern images with one of the devices in accord with the present invention;

FIG. 5A is an illustration showing the use of a computer bit map pattern or image creation software program;

FIG. 5B is an illustration showing the use of a program to store, downward, and preview image patterns;

FIGS. 6A and 6B are block schematic diagrams of circuit that may be employed by an embodiment of the present invention.

### DETAILED DESCRIPTION OF THE EMBODIMENTS

While the invention is susceptible to embodiments in many different forms, there are shown in the drawings and will described herein, in detail, the preferred embodiments of the present invention. It should be understood, however, that the present disclosure is to be considered an exemplification of the principles of the invention and is not intended to limit the spirit or scope of the invention and the embodiments illustrated.

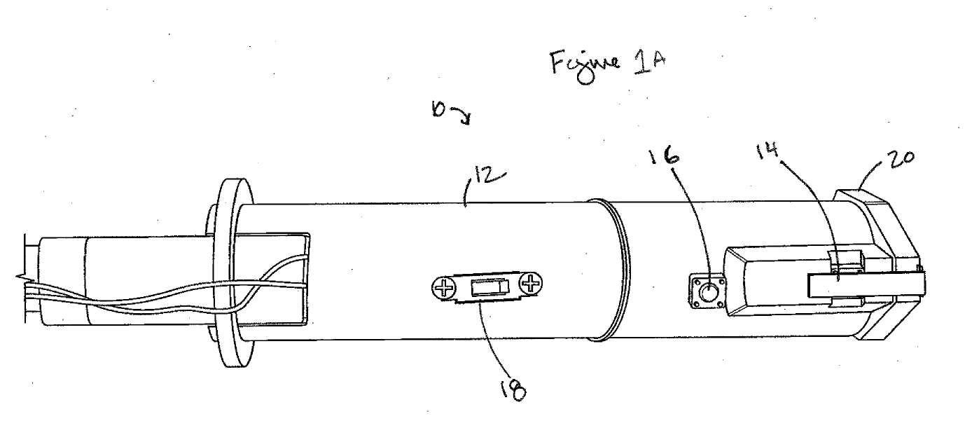

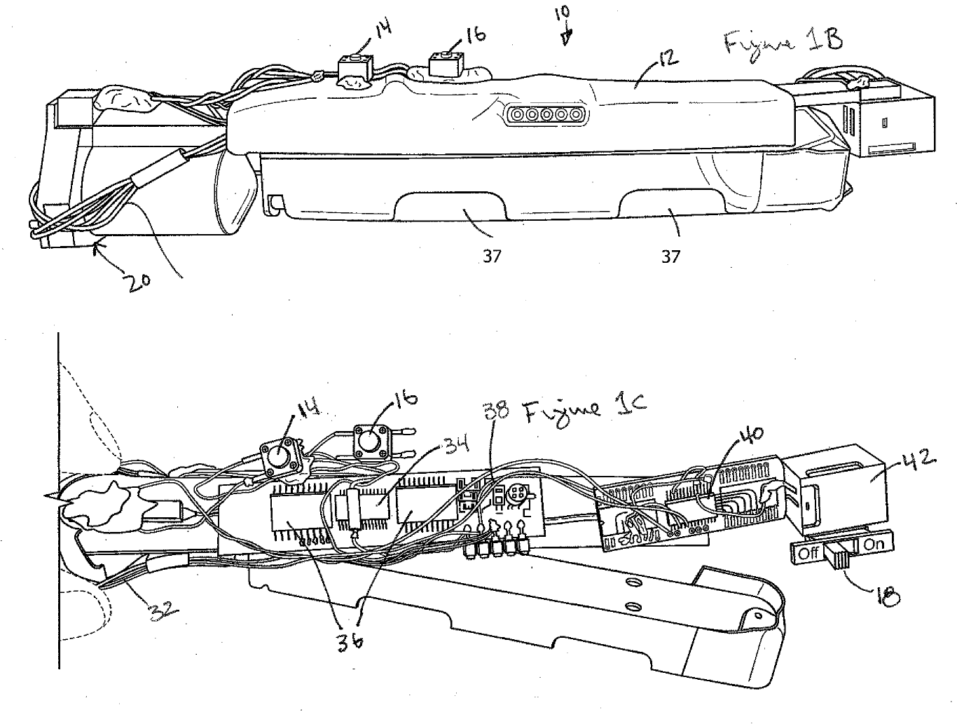

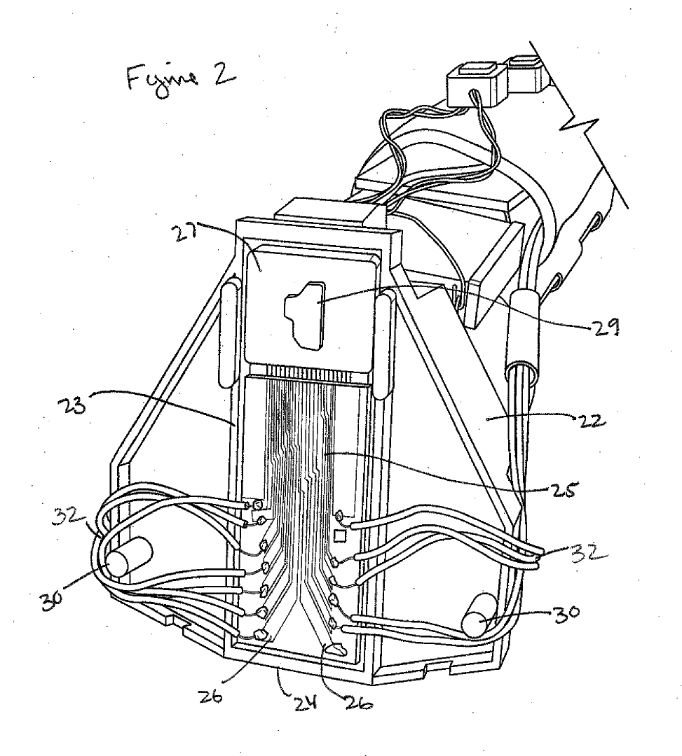

Referring now to FIGS. 1A through 1C, a preferred embodiment of a hand held digital airbrush device 10 comprises, in general, a housing 12, a trigger switch 14, a pattern selector switch 16, an on/off switch 18, and a removably inkjet print cartridge 20. As further disclosed herein below, the device 10 uses an inkjet cartridge which when in communication with a internal microcontroller can be controlled to spray bitmapped images, text, or can be used as an airbrush that has complete control over the amount of ink, width of ink swath, and even color.

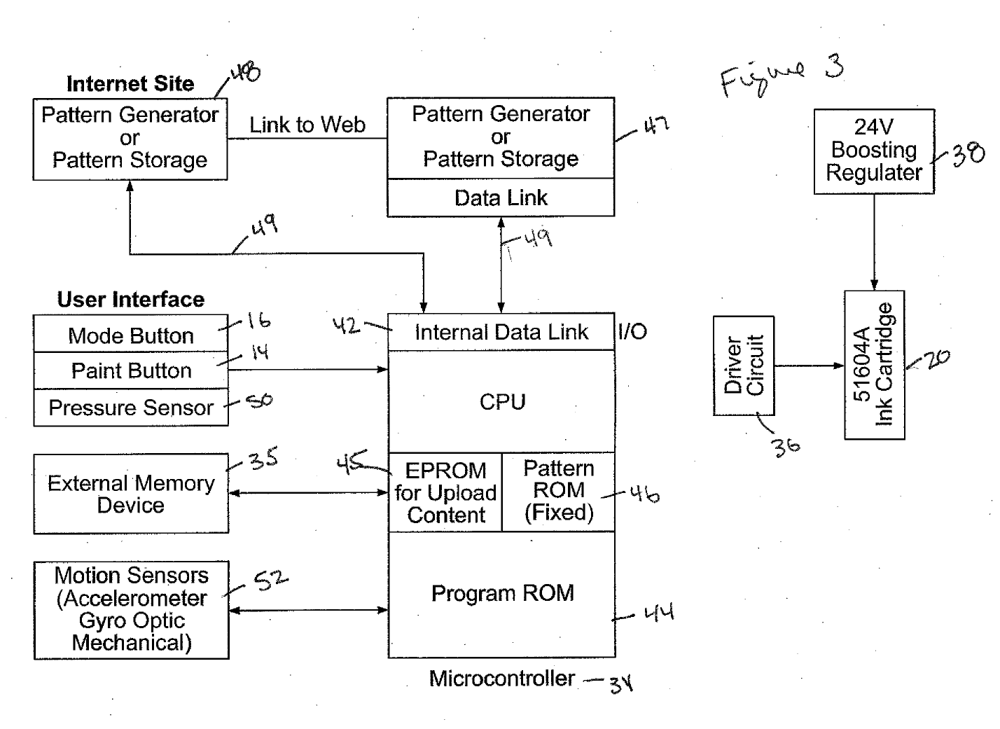

In order to operate the device 10, a replaceable ink jet print/cartridge 20 is placed in the housing 12. Such a print/cartridge is shown in more detail in FIG. 2. The print/cartridge 20 is adapted to be disposable or refillable when empty of ink and in general comprises an ink supply reservoir (not shown), cover member 22 which covers the ink reservoir and coarsely positions the print head assembly 23 in housing 12. The print head assembly 23 comprises a driver plate 24 having a plural of electrical leads 25 formed thereon. The leads 25 extend from connector pads 26 to resistive heater elements (not shown) located beneath orifice plate 27. Ink from reservoir is supplied to a location beneath each orifice 29 of plate 27 (and above the heater element for that orifice). Upon application of an electrical print pulse to a terminal pad by the printer control, the corresponding resistive heater element causes an ink vaporization condition which ejects an ink droplet from its corresponding orifice 29 for printing. The orifice plate 27 can be electroformed using photofabrication techniques to provide precisely located orifices and is attached to driver plate 23, which is in turn affixed to the cover member 22. The print/cartridge 20 has a self-contained ink supply and thermal jet resistors that, when energized, cause the ejection of an ink droplet from the orifice 29.

To help with the targeting of the ink a laser or LED 30 through a simple lens with a fixed focal point could illuminate a dot on the surface where the ink will be sprayed. The dot would also change size depending on the distance from the surface. So as the device 10 is pulled back from the surface its print area grows as well as the dot size, to indicate the area the spray will cover.

A battery pack or power supply 37 is provided within the housing 12 to provide power to the microcontroller 34. A removable end cap (not shown) is provided on housing 12 to facilitate replacement of the battery 37. If desired, a permanent rechargeable battery may be employed for battery 37. In some applications, it may be desirable to use an external power source instead of battery 37 although this would limit the mobility of the operator to some extent, compared to the FIG. 1A embodiment.

As currently illustrated in FIG. 2, connector pads 26 are attached to wires 32 that are in communication with and controlled by a microcontroller 34, shown in FIG. 1C. The microcontroller 34 controls and communicates with the various components of the device 10, including the on/off switch 18, the pattern selector 16, the spray switch 14, inkjet drivers 36, a boosting regulator 38, and a USB chip 40 and USB port connector 42. The boosting voltage regulator 38 converts standard battery voltage to the 24V required by the ink jet cartridge. The ink jet cartridge may be a 51604a or any other thermal or piezo inkjet cartridge, monochromatic or multicolor.

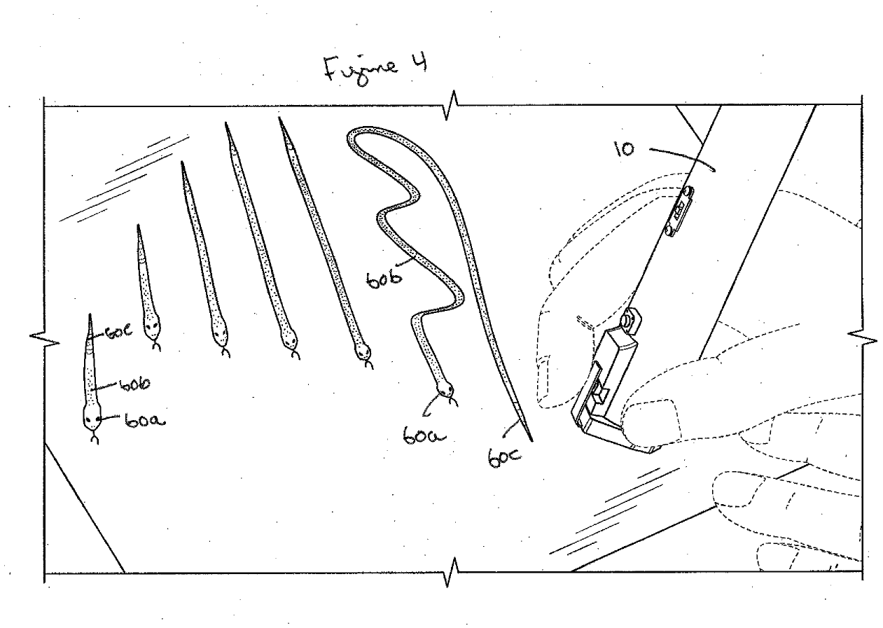

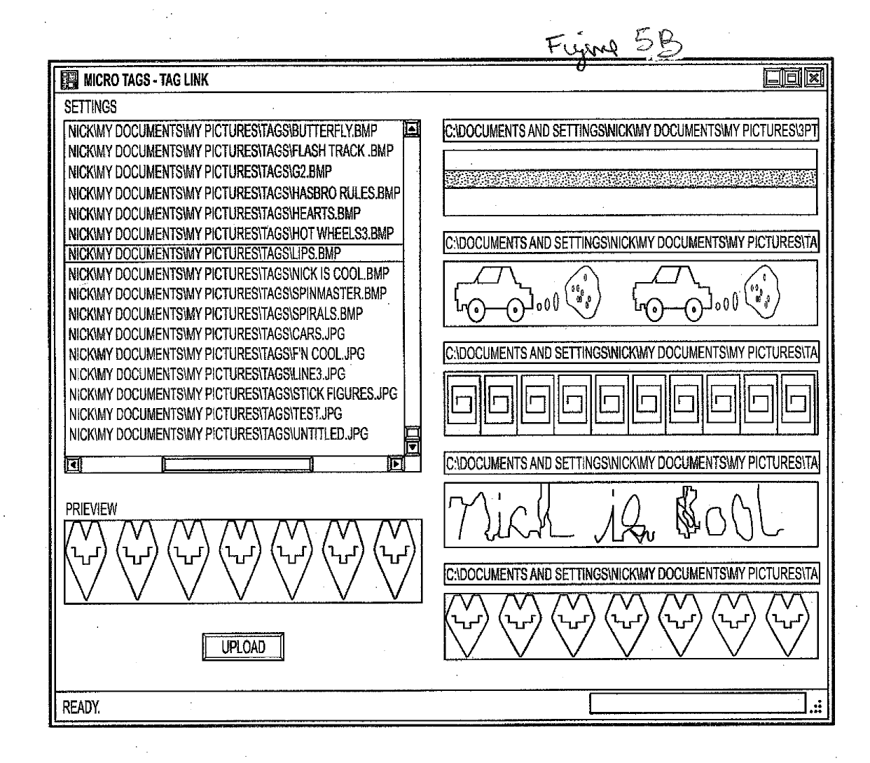

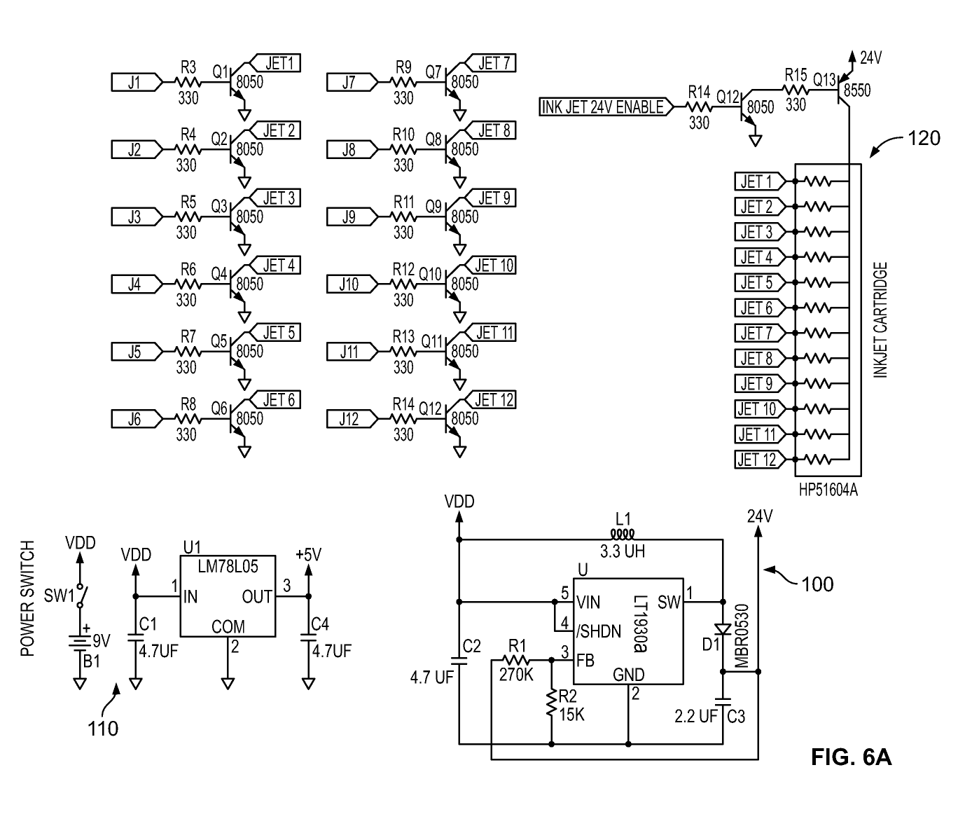

Further shown in FIG. 3, the microcontroller 34 is capable of having memory components 44 or be permitted to read removable media 44, such as SD cards, EEPROM, ROMS, etc which could store bitmap pattern content. Removable media could then be customized via a PC using a proprietary pattern generating program, or any paint program. Therefore, the user can create a pattern using MS Paint included with windows OS, illustrated in FIG. 5a. The user could save the pattern on the SD card with a file name. The SD Card would then be inserted into a slot 45 on the airbrush pen. Now the pattern will be selectable by the user using selection button 16. In addition or separate therefore, the microcontroller 34 could have internal fix memory 46 with patterns pre-programmed.

An internal data link such as the USB port can be used to communicate to a computer 47 and link to the Internet 48 (either through the computer or directly thereto) such that patterns can be generated, downloaded and then stored on the device, illustrated in FIG. 3. While a wired connection to a USB port can be used, wireless communication can also be employed 49. As shown in FIG. 5B, a software window is illustrated with various patterns that are defined and which could be stored on an external memory that are capable of being previewed and transferred to the device.

The present invention airbrush can hold many preprogrammed designs and air brush spray patterns in an internal memory. The number of patterns is dictated only by the memory utilized in its electronic controls. The patterns could be selectable by the pattern selector switch(s) 16 on the outside of the device 10 or sequentially selected by a mode button, or by other interface means. After the pattern is selected, the spray button 14 is pressed and the inkjet starts to spray the pattern. It may be up to the user to control the distance and rate of movement of the airbrush to attain the desired effect. However, spray control could be attained by incorporating a pressure sensor 50 on the face of the inject device that sprays the ink. The pressure sensor 50 senses the pressure applied to control the width of the ink line and or the weight of the ink line's darkness. In another embodiment, a motion feedback system 52 is implemented so the electronic controls can monitor the movement of the device 10. The spacing between ink drops could be automatically adjusted to keep the patterns in perfect aspect no mater how much the user changes the speed of movement while spraying. This feedback system would use optical sensors or mechanical sensors much like a computer mouse, or could use accelerometers or gyros and the likes to monitor movement.

The device could be implemented with a multicolor ink cartridge. Multicolor ink cartridges use 3 or more columns of inkjets each spraying its own color which the electronics control the amount of ink and pattern for each color simultaneously digitally mixing the color to get virtually any color. Another implementation would use food safe food coloring for printing on food. This would have great uses in decorating foods, plates, ice, etc. Another implementation could use water based glue in place of the ink. Then you could spray a glue image and cover in glitter to create glitter images.

The styling of the housing of the device could take many forms including but not limited to a large pen shape, a spray paint can shape, a paint brush shape, or any other hand held ergonomic shape. The device can be used for many applications in many different markets. It can be used on almost every surface, and further it is not limited to flat surfaces. It is useful in all applications where custom labeling, decorating, painting, stamping, or “stickering” is desired on any material surface of any shape contour and size.

Beyond its artistic use as a digitally controlled airbrush for use on canvas or paper, it can be used simply as a pen or marker, or like spray paint. It can be used to label anything. It can be used as an alternative to rubber stamping. It could be used to non-permanently tattoo skin, decorate fingernails. It could be used to apply mailing addresses to envelopes or packages. It could be used to time date stamp perishable items in the restaurant industry. It could be used to spray food coloring on cookies, cakes, and other food items. It could be used to spray a water soluble adhesive to adhere glitter to make glitter images. This could replace the use of stickers, by teachers and children alike. It could be used as a calligraphy pen. It could be used to mark fabrics, and other textiles.

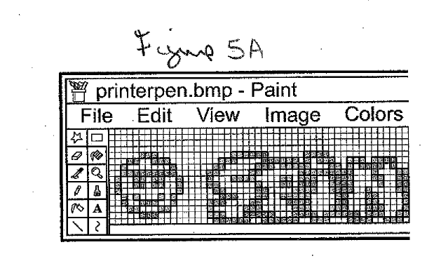

The device could also be programmed to print various images based on the activation of a spray button. For example, in FIG. 4 when spraying the image of a snake, the snake has three components, the head 60a, body 60b, and tail 60c. The user initially presses the spray button to begin the spraying of a head; holding the button will continue spraying the body; and the release of the button will cause the airbrush to spray a tail. The length of the body can change simply by holding the button down for a longer or shorter period of time. The airbrush can also be programmed to follow this in two steps as opposed to three steps as explained above. For example, the spraying of a simply arrow (without a tail). The body of the arrow begins and continues by holding the button, and the release of the button causes the airbrush to spray an arrow head.

In one example, the device works with an inexpensive off the shelf ink cartridge such as a 51604A inkjet cartridge. This cartridge has 12 jets and its paint swath is ⅛″ tall when very close to the paper. The jets also print in a single column. The inkjet squirts ink by applying a 24V pulse of 5 μs to any one of the 12 jets. The jets can only be fired 2 at a time in a specific order 1 and 7, 2 and 8, 3 and 9, 4 and 10, 5 and 11, 6 and 12. After a whole column has been printed there needs to be a 500 μs delay then the next column can be printed. An 8-bit microcontroller with 16 I/O is capable of driving the cartridge. It will need to run at 8 MHZ or better and need something like 8K of ROM and a few bytes of RAM. The driver transistors need to be able to supply 300 ma for 5 μs pulses. These drive transistors can be discreet transistors or could be replaced by transistor array chips like the ULN2803A. If the airbrush uses an USB data link version a microcontroller chip that supports USB directly or one that has a UART serial port would be connected to a USB converter chip like the FTD232R.

For example purposes only, a preprogrammed Spin tag (such as shown in FIG. 5A) is 105×12 pixel bmp it takes up 158 bytes of ROM. A 1K×8 EEPROM can hold 4 tags of this size and 20 12×12 pixel brush nibs. If the airbrush includes an 8K ROM for the micro and dedicated 4K of its ROM to content. The airbrush could store about 26 preprogrammed 100×12 pixel bmps, or 100 12×12 and 13 100×12 bmps. When the spray button is pressed the microcontroller reads the currently selected pattern from internal, external, or the data link, and fires the appropriate ink jet jets via the driver circuitry in the proper sequence. The micro controller controls the timing between columns thereby controlling the spacing of the pattern, and therefore its width at a given speed of movement. Also the microcontroller can print the same column multiple times before moving to the next column to create a darker image. If the device has motion and or position sensors the timing could be controlled so that the pattern spacing is fixed at any rate of movement.

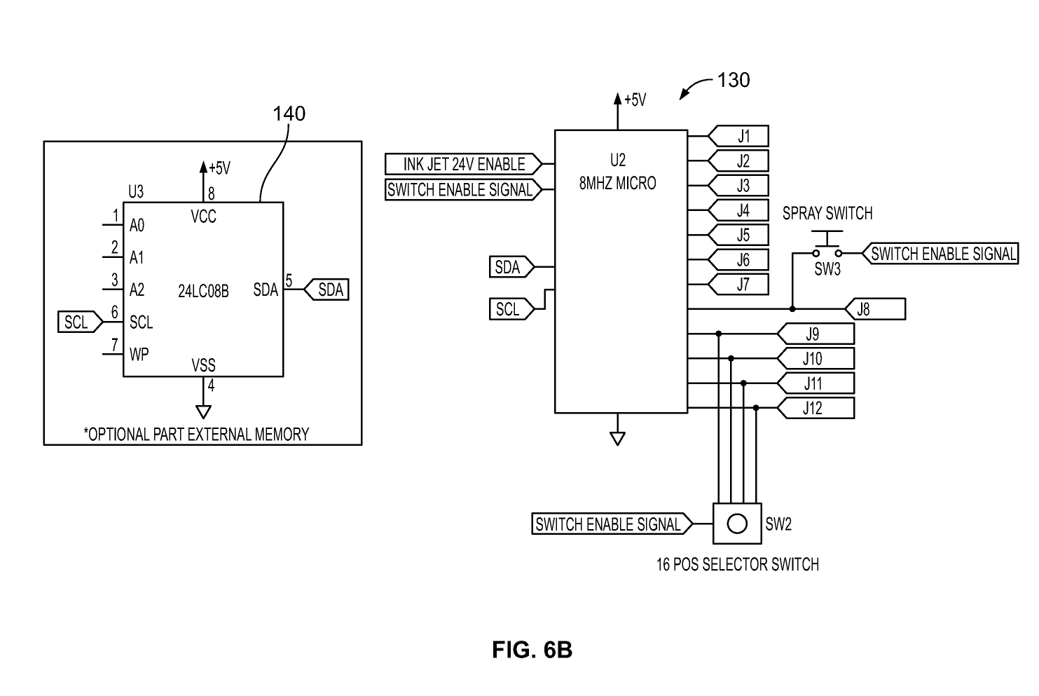

Referring now to FIGS. 6A and 6B, there is shown schematic diagrams for one of the embodiments of the present invention. The diagrams shows in 100 the schematic of a 24 voltage boosting regulator, and a 5 volt regulator in 110. The inkjet cartridge 120 which utilizes the 24 voltage boosting regulator is shown with its 12 jet pins that are further shown connected to pins j1 through j12. The j1 through j12 pins are relayed in FIG. 6B as being connected to the microcontroller 130, which is also powered by the 5 volt regulator 110. The microcontroller 130 includes the selector switch SW2 and the spray switch SW3, which are both illustrated as using the same I/O pins as j8 through 12. To enable the switches, the inkjet is disabled and the switch is then enabled. To fire the jets the inkjet would then be enabled while disabling the switches. In addition, an optional expanded memory chip is shown 140.

The below are software operating functionality code for a device in accordance to one or more of the embodiments outlined herein;

```
#include <htc.h>
#include “delay.h”
#include <stdio.h>
/* Program device configuration word
* Oscillator = HS
* Watchdog Timer = Off
* Power Up Timer = On
* Master Clear Enable = Internal
* Code Protect = Off
* Data EE Read Protect = Off
* Brown Out Detect = BOD and SBOREN disabled
* Internal External Switch Over Mode = Enabled
* Monitor Clock Fail-safe = Enabled
*/
- CONFIG(HS & WDTDIS & PWRTEN & MCLRDIS &
UNPROTECT & BOREN & IESOEN & FCMEN & LVPDIS);
// Peripheral initialization function
void initl (void) {
/***** Common Code ****
  * Peripheral interrupts not enabled
  * Global interrupt disabled during initialization
  */
INTCON = 0b00000000;
PORTC=0;
TRISC=0;
PORTD=0;
TRISD=0;
/***** 16F690 Code ****
* Internal oscillator set to 8MHz
*/
OSCCON = 0b01110000;
ANSELH=0;
ANSEL=0;
TRISA=0xff;
TRISB=0xff;
TRISE=0xff;
RBPU = 0;
// WREN=1;
T1OSCEN=0;
TMR1CS=0;
T1CKPS1=1; // 11 = /8
T1CKPS0=1; // 10 = /4
TMR1H=0;
TMR1L=0;
TMR1IF = 0;
TMR1ON = 1;
PSA=1; // psa = 1 prescaler to WDT
PS0=0; // 111 - prescaler set to /256
PS1=0; // 000 - /2
PS2=0; // 001 - /4
```

The below are software operating functionality code for a device in accordance to one or more of the embodiments outlined herein;

```
T0CS=0; // Timer increments on instruction clock
T0IF=0;
}
const unsigned char printrerpen[ ]={
0,224,24,4,212,202,10,202,212,4,24,224,0,0,0,0,206,107,59,17,145,129,135,142,126,51,
3,1,209,217,63,254,254,227,1,3,230,254,254,227,3,1,63,158,198,1,1,227,254,254,102,99
,1,51,159,62,1,3,247,255,243,193,3,159,159,25,129,241,255,11,73,237,205,193,243,255
,248,96,124,126,3,7,61,127,248,248,204,12,166,166,162,227,243,255,255,1,195,223,142
,99,241,249,153,13,7,3,0,0,0,0,0,3,5,5,9,9,9,5,5,3,0,0,0,0,0,1,3,6,4,12,8,8,9,11,14,6,4,
6,6,6,3,15,9,13,13,7,3,1,7,4,6,7,6,4,6,1,1,3,6,6,4,7,7,4,4,6,6,14,15,11,8,9,12,14,7,1,1,3,6,
4,5,4,6,7,6,4,6,15,8,15,15,66,4,7,6,6,12,12,8,13,15,3,2,13,9,9,12,7,3,1,0,0,0,0,0,0,0
};
const unsigned char skull[ ]={
25,27,10,138,94,138,10,27,25,0, 0, 0, 7, 13,15, 13, 7, 0, 0,0
};
const unsigned char brush1[ ]={1,0};
const unsigned char brush2[ ]={7,0};
const unsigned char brush3[ ]={0x0f,0};
const unsigned char brush4[ ]={0x1f,0};
const unsigned char brush5[ ]={0x3f,0};
const unsigned char brush6[ ]={0x3f,1};
const unsigned char brush7[ ]={0x7f,0};
const unsigned char brush8[ ]={0xff,0};
const unsigned char brush9[ ]={0xff,0x0f};
const unsigned char g2[ ]={
24,188,236,12,108,76,70,67,65,65,70,108,56,2,7,13,153,217,218,74,105,45,133,197,101
,61,25,1,0,0,0,0,12,234,25,1,12,249,35,60,0,128,56,60,254,254,252,220,224,56,254,255,
126,60,16,0,128,224,240,127,254,252,224,0,0,0,0,0,0,48,24,220,252,188,6,190,159,15,14
,6,4,0,0,128,56,60,254,254,252,220,224,56,254,255,126,60,16,
0,128,128,66,130,255,7,192,128,128,0,0,8,12,252,255,247,62,24,0,0,60,126,254,207,143
,207,255,63,31,6,0,128,56,60,254,254,252,220,224,56,254,255,126,60,28,252,254,254,
191,255,248,224,128,0,0,0,0,0,0,0,0,7,13,6,2,6,12,12,12,8,8,9,11,14,4,0,3,7,12,8,8,6,3,1,
0,0,0,0,0,0,0,0,0,0,0,9,7,9,9,9,11,4,1,3,3,7,7,3,3,0,0,15,5,0,0,8,15,7,7,7,0,8,15,15,14,12,10
,10,12,0,0,0,1,1,1,3,3,3,7,6,4,0,0,1,3,3,7,7,3,3,0,0,15,5,0,0,8,7,7,3,3,15,7,3,1,1,3,3,4,0,3
,11,13,13,12,0,0,14,15,4,0,3,37,3,1,1,0,0,1,3,3,7,7,3,3,0,0,15,5,0,0,0,1,3,7,12,14,14,12,8,
0,0,0,0,0,0,0,0,
};
void printBmp(const unsigned char *c,unsigned char size,
unsigned char delay,unsigned char delay1);
unsigned char x=6;
void
main(void)
{
initl( );
DelayMs(100);
while (1)
{
if(!RB1);
{
while(!RB1);
  x++;
  if(x>8)x=0;
}
if(!RB0)
{
  do
  {
  switch(x)
  {
  /*
  case 0: printf(“ SPIN ? ”); break;
  case 1: printf(“ CRAY ? ”); break;
  case 2: printf(“ MAT ? ”); break;
  case 3: printf(“ G2 Inventions ”); break;
  case 4: printf(“ BUY ME ”); break;
  case 5: printf(“ Print on ANYTHING... ”); break;
  case 6: printf(“ Printer Pen By G2 Inventions. ”); break;
  case 7: putch(‘>’);break;
  case 8: putch(0x7f);break;
  case 9:putch(3);break;
  */
  case 0: printBmp(brush1,1,1,1);break;
  case 1: printBmp(brush2,1,1,1);break;
  case 2: printBmp(brush3,1,1,1);break;
  case 3: printBmp(brush5,1,1,1);break;
  case 4: printBmp(brush7,1,1,1);break;
  case 5: printBmp(brush9,1,1,1);break;
  case 6: printBmp(printrerpen,110,8,12);break;
  case 7: printBmp(g2,160,5,12);break;
  case 8: printBmp(skull,10,8,12);break;
  }
  }While(!RB0);
  }
}
}
```

The below is software printing functionality code for a device in accordance to one or more of the embodiments outlined herein;

```
#include <htc.h>
#include“ASCII.H”
#include“delay.h”
void putch (char c)
{
char Z,x;
unsigned char mask;
unsigned char RCbyte, RDbyte;
  for(Z=4;Z<=4;Z−−)
  {
  RCbyte = (ASCII[c][Z]) & (0x3f);
  RDbyte = ((ASCII[c][Z]) & (0xc0))>>6;
  mask=0x01;
  for(x=0;x<6;x++)
  {
    PORTC=mask&RCbyte;
    PORTD=mask&RDbyte;
    DelayUs(6);
    PORTC=0x00;
    PORTD=0x00;
    DelayUs(3);
    mask<<=1;
  }
  DelayMs(6);
  }
  DelayMs(12);
}
void printBmp (const unsigned char *c, unsigned char size,unsigned char
delay, unsigned char delay1) {
char Z,x;
unsigned char mask;
unsigned int temp;
unsigned char RCbyte, RDbyte;
for(Z=0;Z<size;Z++)
{
RCbyte = c[Z] & 0x3f;
RDbyte = (c[Z] & 0xc0)>>6;
temp = size+Z;
RDbyte = ((c[temp]&0x0f)<<2);
mask=0x20;
for(x=0;x<6;x++)
{
  PORTC=mask&RCbyte;
  PORTD=mask&RDbyte;
  DelayUs(6);
  PORTC=0x00;
  PORTD=0x00;
  DelayUs(3);
  mask>>=1;
}
mask=0x20;
DelayUs(200);
DelayUs(200);
DelayUs(200);
for(x=0;x<6;x++)
{
  PORTC=mask&RCbyte;
  PORTD=mask&RDbyte;
  DelayUs(6);
  PORTC=0x00;
  PORTD=0x00;
  DelayUs(3);
  mask>>=1;
}
DelayMs(delay);
DelayUs(200);
}
DelayMs(delay1);
}
```

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A hand-held ink jet device constructed for use with insertable ink jet print/cartridges to produce ink droplet streams, said device comprising:
a memory capable of storing at least one image pattern;
an ink jet print/cartridge of the type having a self-contained ink supply, a plurality of orifices and a plurality of discrete jets energizable respectively for ejection of ink droplets through such orifices;
a plurality of discrete drivers electrically coupled to said plurality of discrete print/cartridge jets, said drivers being selectively actuatable for providing ink jetting electrical energy pulses;
a selector switch for electively choosing one of the at least one image patterns stored on said memory; and
a spray switch for selectively actuating said discrete drivers to provide electrical energy pulses to energize their respective jets in order to spray ink from the self-contained ink supply in the shape of the selected image pattern.

2. The device of claim 1, wherein the memory has stored at least two image patterns.

3. The device of claim 1, wherein the selected image pattern has multiple component images, and the activation and deactivation of the spray switch is capable of rendering different component images of the selected image pattern.

4. The device of claim 1 further comprising a visual indicator light positioned on a front surface of the device adjacent or near the plurality of orifices, the visual indicator light capable of casting a fixed focal light point on a surface to indicate the area the ink will spray.

5. The device of claim 1, wherein the ink is a printing ink, a food grade edible ink, a water soluble adhesive, or paint.

6. The device of claim 1 further comprising a pressure sensor in communication with a microcontroller to control the width or weight of the ink line.

7. The device of claim 1 further comprising a motion feedback sensor capable of monitoring the movement of the front surface of the device adjacent or near the plurality of orifices across a surface, the motion feedback sensor in communication with a microcontroller to control a timing of the activation of the jets in response to the movement of the device.

8. A hand-held ink jet device constructed for use with insertable ink jet print/cartridges to produce ink droplet streams, said device comprising:
a memory capable of storing at least one image pattern;
an ink jet print/cartridge of the type having a self-contained ink supply, a plurality of orifices and a plurality of discrete jets energizable respectively for ejection of ink droplets through such orifices;
a plurality of discrete drivers electrically coupled to said plurality of discrete print/cartridge jets, said drivers being selectively actuatable for providing ink jetting electrical energy pulses;
a selector switch for electively choosing one of the at least one image patterns stored on said memory;
a spray switch for selectively actuating said discrete drivers to provide electrical energy pulses to energize their respective jets in order to spray ink from the self-contained ink supply in the shape of the selected image pattern; and
a visual indicator light positioned on a front surface of the device adjacent or near the plurality of orifices, the visual indicator light capable of casting a fixed focal light point on a surface to indicate the area the ink will spray.

9. The device of claim 8, wherein the memory has stored at least two image patterns.

10. The device of claim 8, wherein the selected image pattern has multiple component images, and the activation and deactivation of the spray switch is capable of rendering different component images of the selected image pattern.

11. The device of claim 8, wherein the ink is a printing ink, a food grade edible ink, a water soluble adhesive, or paint.

12. The device of claim 8 further comprising a pressure sensor positioned on a front surface of the device adjacent or near the plurality of orifices to measure an ink pressure applied to a surface, the pressure sensor in communication with a microcontroller to control the width or weight of the ink line in response to the pressure applied to a surface.

13. The device of claim 8 further comprising a motion feedback sensor capable of monitoring the movement of the front surface of the device adjacent or near the plurality of orifices across a surface, the motion feedback sensor in communication with a microcontroller to control a timing of the activation of the jets in response to the movement of the device.

14. A hand-held ink jet device constructed for use with insertable ink jet print/cartridges to produce ink droplet streams, said device comprising:
a memory capable of storing at least one image pattern;
an ink jet print/cartridge of the type having a self-contained ink supply, a plurality of orifices and a plurality of discrete jets energizable respectively for ejection of ink droplets through such orifices;
a plurality of discrete drivers electrically coupled to said plurality of discrete print/cartridge jets, said drivers being selectively actuatable for providing ink jetting electrical energy pulses;
a selector switch for electively choosing one of the at least one image patterns stored on said memory;
a spray switch for selectively actuating said discrete drivers to provide electrical energy pulses to energize their respective jets in order to spray ink from the self-contained ink supply in the shape of the selected image pattern and
a motion feedback sensor capable of monitoring the movement of the front surface of the device adjacent or near the plurality of orifices across a surface, the motion feedback sensor in communication with a microcontroller to control a timing of the activation of the jets in response to the movement of the device.

15. The device of claim 14, wherein the memory has stored at least two image patterns.

16. The device of claim 14, wherein the selected image pattern has multiple component images, and the activation and deactivation of the spray switch is capable of rendering different component images of the selected image pattern.

17. The device of claim 14 further comprising a visual indicator light positioned on a front surface of the device adjacent or near the plurality of orifices, the visual indicator light capable of casting a fixed focal light point on a surface to indicate the area the ink will spray.

18. The device of claim 14, wherein the ink is a printing ink, a food grade edible ink, a water soluble adhesive, or paint.

19. The device of claim 14 further comprising a pressure sensor positioned on a front surface of the device adjacent or near the plurality of orifices to measure an ink pressure applied to a surface, the pressure sensor in communication with a microcontroller to control the width or weight of the ink line in response to the pressure applied to a surface.

20. The device of claim 6, wherein the pressure sense is positioned on a front surface of the device adjacent or near the plurality of orifices to measure an ink pressure applied to a surface.
